(19) United States
(12) Patent Application Publication
(10) Pub. No.: US 2009/0061158 A1
(43) Pub. Date: Mar. 5, 2009

(54) Friction profile for the top of pool grate bars

(76) Inventor: Robert Lawson, Naples, FL (US)

Correspondence Address: LAWSON AQUATICS, 4431 Corporate Square, Naples, FL, 34104, US

(21) Appl. No.: 12/287,007

(22) Filed: Oct. 6, 2008

Related U.S. Application Data
(63) Continuation-in-part of application No. 11/825,696, filed on Jul. 10, 2007.

(51) Int. Cl. B32B 3/30

(52) U.S. Cl. 428/156

(57) ABSTRACT

An inventive top profile design of friction ridges on a top surface of grate bars in a swimming pool deck. The profiles exhibit a multiple of crosses with each cross having four quadrants. Within each of the quadrants there is located a first right angled profile which is open in an outward direction. Within each of the first right angled profile there is located a second smaller right angled profile which is also open in an outward direction. The above mentioned profiles repeat themselves along the entire length of the grate bars.

This application is a continuation-In-Part of application Ser. No. 11/825,696 having a filing date of Jul. 10, 2007

### BACKGROUND OF THE INVENTION

Swimming pools have various ways of cleaning the water including any floating debris on the surface of the water. One way is to let the water drain into a filter box having a floating weir therein. Another way is to let the water overflow or slosh onto a grate bar system which covers a sump extending around the perimeter of the pool. The grate bar system is being installed over the top of the sump. The grate bar system is even with the surface of the concrete walk which extends around the pool as a walk way.

### BRIEF DESCRIPTION OF THE INVENTION

The water sloshing over the grate bar system constantly keeps the surface of the grate bar system wet. It is also of the utmost importance that the surface of the grate bars is as slippery-proof as possible. There are known grate bars having a friction surface made up of ribs that run parallel to the longitudinal extent of the pool and there are grate bars having a friction surface made up of ribs that run perpendicular to the longitudinal extent of the pool. The perpendicular ribs have shown to be most useful because the water that accumulates between the ribs tends to empty quicker than the ribs running longitudinally to the pool. The copending application discloses a top profile design for grate bars exhibiting right angled ridges which are stacked relative to each other in a direction which is perpendicular to a longitudinal direction of the grate bars to thereby represent the form of a chevron. However, it has been found that the inventive rib profile is most beneficial in emptying the water there from. The inventive profile consists of angular ribs that are stacked within each other in multiple directions.

### BRIEF DESCRIPTION OF THE INVENTION

The inventive rib friction profile is so designed that many top rib surfaces present themselves to the underside of a foot of a person traversing the parallel grate bars. The multiple of rib surfaces include a multiple of crosses with each cross having four quadrants. Each of the quadrants are filled with right angled ribs that diminish in size from the center of the cross outwardly until the right angled profiles encounter the next and adjacent cross. This way, there is a multitude of ribs present on the top surface of the grate bars. This design is instrumental in quickly emptying any water back into the sump over which the grate bars are installed. This design also increases the coefficient of friction above 1.00 ASTM present on the top surface of all of the grate bars. This design also reduces the water traveling over the grate bars because the water is quickly drained away between the various grate bars. No water can accumulate between the various profiles which prevents any forming of a possible mold. In addition, these profiles do not have any sharp edges to cause any injuries. Lastly, this profile helps the grate bars staying clean because no stains can form.

### BRIEF DESCRIPTION OF THE DRAWINGS

FIG. 1 shows an installation of grate bars on lateral supports;

Fig. illustrates a top view of frictions ridges on a grate bar.

### DETAILED DESCRIPTION OF THE INVENTION

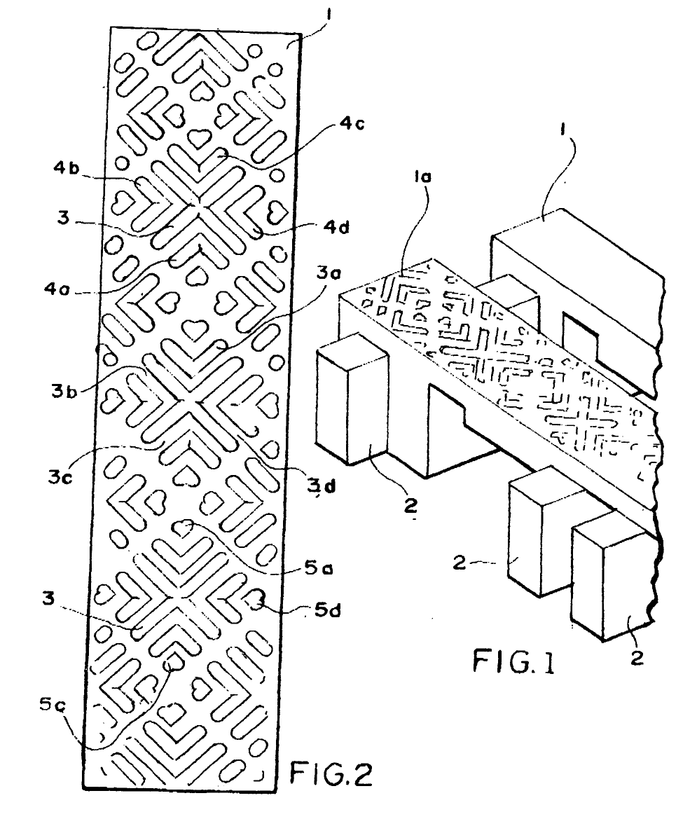

FIG. 1 is as a simplified view of how grate bars 1 and 1a are installed in a gutter on a swimming pool deck. This is a well known installation were grate bars 1 are placed over lateral supports 2 which straddle the gutter in a swimming pool deck. The grate bars are normally installed parallel to each other and a longitudinal direction of the swimming pool.

FIG. 2 shows the inventive profile on the surface of the grate bar 1. On top of the grate bar there are a multiple of raised cross 4 profiles. Each of the crosses 4 has four quadrants. Each of the quadrants is filled in an outward direction with right angles 4a, 4b, 4c and 4b. The ridges of the right angles have the same height as the multiple of crosses. In a further outward direction from the right angles 4a, 4b, 4c and 4d there are further smaller right angles 5a, 5b, 5c and 5d. This pattern repeats itself over the whole length of the grate bar.

What I claim is:

1. A top profile design for grate bars in a swimming pool, said design includes a multiple of crosses having at least four quadrants, in each of the quadrant there is located a first right angled rib, the right angle being open in an outward direction, there is further located within each of said first right angled ribs second smaller right angled ribs which are also open in an outward direction, the crosses with their first and second right angled profiles in each of the quadrants repeat themselves along the entire length of the grate bar.
